(19) United States
(12) Patent Application Publication
(10) Pub. No.: US 2006/0167136 A1
(43) Pub. Date: Jul. 27, 2006

(54) Method of manufacturing dispersible colorant and ink-jet recording ink

(75) Inventors: Toshiaki Kaneko, Tokyo (JP); Masashi Miyagawa, Yokohama-shi (JP); Makoto Aoki, Yokohama-shi (JP); Junichi Sakai, Tokyo (JP); Yoshio Nakajima, Yokohama-shi (JP); Yoko Ichinose, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/321,463

(22) Filed: Dec. 30, 2005

Related U.S. Application Data
(63) Continuation of application No. PCT/JP05/12294, filed on Jun. 28, 2005.

(30) Foreign Application Priority Data
Jun. 28, 2004 (JP) 2004-190472 (PAT.

(51) Int. Cl. C03C 17/00; C09D 11/00; C08G 73/02

(52) U.S. Cl. 523/160; 523/161; 524/800

(57) ABSTRACT

A dispersible colorant suitable for ink-jet recording ink is manufactured by a method using aqueous precipitation polymerization. The ink has high dispersion stability and can form a high-quality image excellent in fastness properties. The method includes at least a dispersing step of dispersing a colorant into an aqueous solution by means of a dispersant, an aqueous precipitation polymerization step of adding a resin monomer and a radical polymerization initiator to the solution into which the colorant is dispersed to manufacture a dispersible colorant having a chargeable resin pseudo-fine particle, fixing thereon by means of aqueous precipitation polymerization, and an ultrafiltration step of subjecting the aqueous solution containing the dispersible colorant to ultrafiltration to obtain the dispersible colorant.

This application is a continuation of International Application No., PCT/JP2005/012294, filed on Jun. 28, 2005, which claims the benefit of Japanese Patent Application No. 2004-190472 filed on Jun. 28, 2004.

### BACKGROUND OF THE INVENTION

1. Field of the Invention

The present invention relates to a method of manufacturing a dispersible colorantcolorant; and an ink-jet recording ink containing a dispersible colorantcolorant obtained by means of thee method.

2. Related Background Art

An ink-jet system is a process for recording an image, characters, or the like by making minute liquid droplets of ink to fly out of nozzles onto a recording medium (e.q., paper) with any of various operating principles, and facilitates high speed, low-noise, and multicolor recording. Besides, the ink jet system is characterized in higher versatility of recording patterns and no manipulation for development and fixation, and has rapidly become popular in various applications. In recent years, particularly, technologies for a full color ink-jet recording system with aqueous ink have been remarkably developed, allowing the formation of a color image without inferiority in comparison to any multicolor recording by the conventional plate-making system or any copy formed by the conventional color photographic system. When the number of copies to be printed is small, the ink-jet recording system attains printed articles more cheaply than those obtained by the conventional multicolor printing or copy. Therefore, the ink-jet recording system becomes widespread in the field of full color image-recording.

Furthermore, in association with improvements of recording properties such as high speed, high definition, and full-color, an ink-jet recording apparatus and an ink-jet recording method have been improved. In general, for example, ink-jet recording ink for use in an ink-jet recording apparatus is requested to: (1) provide a high-resolution, high-density, and uniform image causing neither feathering nor fog on paper; (2) provide good ejection responsiveness and good ejection stability at all times without causing clogging due to the drying of ink at the tip of a nozzle; (3) provide good fixability of ink on paper; (4) provide a formed image with good fastness properties (such as rub-off resistance); and (5) provide good long-term storage stability. In particular, in association with a recent increase in printing speed, ink which can be dried and fixed quickly and which allows an image with high quality to be recorded has been requested.

ColorantColorants used in the ink-jet recording system mainly include dyes and pigments. In terms of manageability and high coloring property for aqueous ink, conventionally, a water-soluble dye has been mainly used. However, in late years, the development of ink using, as a colorantcolorant for aqueous ink capable of realizing higher weatherability of an image, an essentially water-insoluble colorantcolorant, particularly pigment has been advanced. For the use of a water-insoluble colorantcolorant, particularly a pigment as aqueous ink, there is a need of stably dispersing the colorantcolorant into water. In this case, conventionally, the process for attaining stability in dispersion typically using a surfactant or a polymer-dispersant (also referred to as a dispersion resin) has been employed.

Alternatively, there is proposed a procedure for chemically modifying the surface of a water-insoluble colorantcolorant to make the water-insoluble colorantcolorant self dispersible (see, for example, JP 10-195360 A). On the other hand, microcapsule type pigments that are covered with resin have been proposed (see, for example, JP 08-183920 A and JP 2003-34770 A) In JP 2003-34770 A, there is disclosed “an aqueous dispersion of colored fine particles, characterized by comprising a water-insoluble coloring agent, where the water-insoluble coloring agent was dispersed into an aqueous medium in the presence of a dispersant and then added with a vinyl monomer to initiate polymerization, wherein the dispersion shows dispersion stability when the dispersant has dispersed the water-insoluble coloring agent, while the latex caused has poor dispersion stability when the vinyl monomer was polymerized in the presence of only the dispersant”. “When the emulsion polymerization of a vinyl monomer with a dispersion of water-insoluble coloring agent occurs, the dispersant is hardly detached from the surface of pigments and the polymerization occurs on the surface of pigments adsorbing the dispersant because of insufficient affinity of the dispersant to the vinyl monomer or the obtained polymer”. Therefore, “a dispersion of fine particles or pigments the surface of which is covered, can be obtained in high yield without causing aggregation”. The use of the dispersion of colored fine particles results in aqueous ink having excellent dispersion stability and print adequacy with no paper-type dependency and little metallic luster, while being excellent in water resistance, light resistance, and rub-off resistance.

### SUMMARY OF THE INVENTION

However, the technology described above may be insufficient in dispersion stability of a colorantcolorant and gloss of a recorded image. According to the study of the inventors of the present invention, the surface functional group density on a colorantcolorant should be raised in order to enhance dispersion stability. However, in the conventional procedure using a polymer dispersant or the procedure, in which pigments are covered with a resin, proposed in JP 08-183920 A, long-term storage stability may be hardly sustained as the resin tends to be detached from the colorantcolorant with time because of an increase in hydrophilicity of the resin, in proportion to an increase in acid value of the resin to enhance dispersion stability. On the other hand, in an approach to chemically modifying the surface of a water-insoluble colorantcolorant by means of a method disclosed in JP 10-195360 A, the kinds and density of functional groups with which the surface can be modified are limited. In addition, direct chemical modification of a colorantcolorant, especially an organic pigment, involves the occurrence of so-called “pigment-detachment” in which a pigment molecule which is intrinsically insoluble in water to be crystallized is solubilized by bonding with a hydrophilic group to be eluted from a pigment particle. As a result, a color tone significantly changes (see FIGS. 6A and 6B). Therefore, the approach is not at a sufficiently satisfactory technical level.

An object of the present invention is to provide a method of manufacturing a dispersible colorantcolorant which: has solved those conventional problems; has sufficiently high dispersion stability; is not detached from a resin component; can form a high-quality image excellent in fastness properties; hardly contaminates a face surface of a head when it is used for ink-jet recording ink; hardly causes kogation on a heater board; and can provide excellent ejection stability, and to provide an ink-jet recording ink containing the dispersible colorantcolorant.

The inventors of the present invention have made extensive studies about means for achieving the above object. As a result, they have achieved the development of a method of manufacturing a novel dispersible colorantcolorant which: maintains high dispersion stability; is not detached from a resin component; and is excellent in storage stability for a long time period, the dispersible colorantcolorant having a novel shape. The inventors have used such dispersible colorantcolorant to manufacture ink-jet recording ink which: has ejection stability and dispersion stability sufficient for ink-jet recording applications; can form a high-quality image excellent in fastness properties such as rub-off resistance; hardly contaminates a face surface of a head; and hardly causes kogation on a heater board.

That is, according to one aspect of the present invention, there is provided a method of manufacturing a dispersible colorantcolorant using aqueous precipitation polymerization including at least: a dispersing step of dispersing a colorantcolorant into an aqueous solution by means of a dispersant; an aqueous precipitation polymerization step of adding a resin monomer and a radical polymerization initiator to the solution into which the colorantcolorant is dispersed to manufacture a dispersible colorantcolorant having a chargeable resin pseudo-fine particle fixing on the colorantcolorant by means of aqueous precipitation polymerization; and an ultrafiltration step of subjecting the aqueous solution containing the dispersible colorantcolorant to ultrafiltration to manufacture a dispersible colorantcolorant

According to another aspect of the present invention, there is provided an ink-jet recording ink containing a dispersible colorantcolorant obtained by means of the above manufacturing method.

According to the present invention, a dispersible colorantcolorant on which a chargeable resin pseudo-fine particle fixes suitable for ink-jet recording ink can be selectively obtained with high degree of purity through an extremely simple aqueous precipitation polymerization step not involving the use of a water-insoluble solvent by placing an ultrafiltration purification step after the aqueous precipitation polymerization step. Ink containing a dispersible colorant on which a chargeable resin pseudo-fine particle fixes obtained by means of the manufacturing method is very excellent in ejection stability while it has the colorant dispersed by a resin.

### BRIEF DESCRIPTION OF DRAWINGS

FIGS. 1A and 1B are schematic views for illustrating the basic structure of a dispersible colorant obtained by the present invention on (to) which chargeable resin pseudo-fine particles fix (fuse);

FIGS. 2A, 2B, 2C, and 2D are schematic views of typical steps of the manufacturing method of the present invention, respectively;

FIG. 3 is a schematic view for illustrating the steps of producing chargeable resin pseudo-fine particles and allowing the particles to fix (fuse) on (to) a colorant in the manufacturing method of the present invention;

FIG. 4 is an enlarged schematic view of chargeable resin pseudo-fine particles obtained by the present invention viewed from an interface on which the particles fix (fuse) on (to) the colorant;

FIG. 5 is an enlarged schematic view of the interface on which the chargeable resin pseudo-fine particles obtained by the present invention fix (fuse) on (to) the colorant; and

FIGS. 6A and 6B are schematic views of a pigment-detachment phenomenon occurred at the time of direct modification with a hydrophilic group on an organic pigment, represented by JP 10-195360 A.

### DESCRIPTION OF THE PREFERRED EMBODIMENTS

Hereinafter, the present invention will be described in more detail by way of a preferred embodiment.

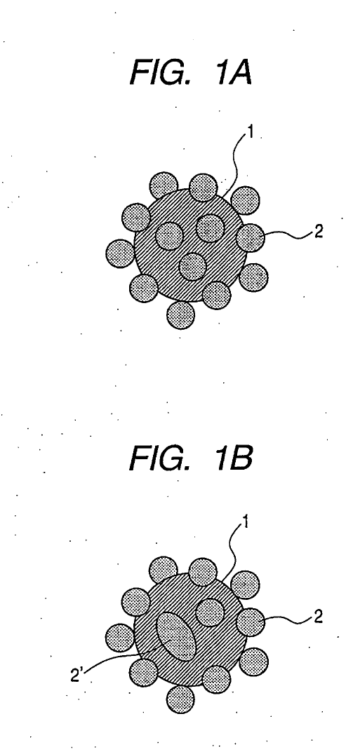

A first feature of a dispersible colorant manufactured by the present invention lies in that the dispersible colorant includes a colorant and a chargeable resin pseudo-fine particle, and the colorant has the chargeable resin pseudo-fine particle fixing thereon. FIGS. 1A and 1B are schematic views each showing a dispersible colorant having a colorant 1 on which chargeable resin pseudo-fine particles 2 fix, which characterizes the present invention. The part 2′ shown in FIG. 1B is a part schematically showing a state in which part of the chargeable resin pseudo-fine particles 2 fixing on the surface of the colorant 1 fuse.

A chargeable resin pseudo-fine particle fixes on a colorant, whereby charge is imparted by the chargeable resin pseudo-fine particle to the surface of the colorant. As a result, the colorant becomes a dispersible colorant that can be dispersed into water or an aqueous ink medium. At the same time, the dispersible colorant has excellent adhesiveness to a recording medium because it has a resin component fixing on its surface. At this time, the chargeable resin pseudo-fine particle does not adhere to the colorant owing to mere physical adsorption of the resin component, but fixes on the colorant, which is characteristic of the dispersible colorant to be used in the present invention. As a result, the chargeable resin pseudo-fine particle is not detached from the surface of the colorant. Therefore, the dispersible colorant to be used in the present invention is excellent in long-term storage stability as well.

Here, the term “chargeable resin pseudo-fine particle” as used herein refers to a resin aggregate in a state where resin components are strongly aggregated. Preferably, in the resin aggregate, many physical cross-linkages are formed (the resin aggregate is resin components having a stable configuration as a fine particulate configuration or a minute aggregate close to the fine particle configuration). The details of the chargeable resin pseudo-fine particles will be described later.

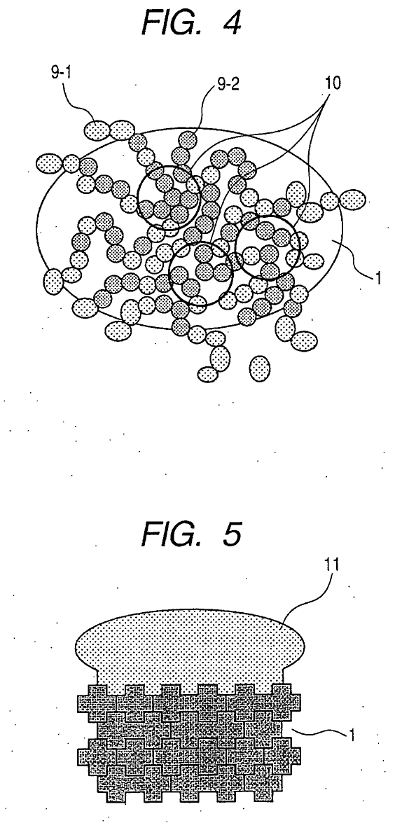

The state in which the chargeable resin pseudo-fine particle fixes on the colorant in the present invention depends on a strong interaction between the surface of the colorant and the chargeable resin pseudo-fine particle. The state may be expected as the following. FIG. 4 shows an enlarged schematic view of the interface, between the chargeable resin pseudo-fine particle and the colorant. First of all, the chargeable resin pseudo-fine particle 2 is formed by intertwined polymers composed of various monomer unit compositions (represented by 9-1 and 9-2 in the figure). On the interface with the colorant, the polymers locally take various structures and hence cause variations in their local surface energy states, respectively. At a point (part shown by a black circle in the figure) where the surface energy caused from the chemical and surface structures of the colorant and the surface energy caused from the chemical and surface structures of the polymer are locally well coincident with each other, the colorant and the polymer are tightly bound together. Furthermore, on the interface where one of the chargeable resin pseudo-fine particles interfaces on the colorant, as shown in FIG. 4, there are multiple points such as those represented by 10, where the surface energies of both the colorant and the polymer are locally coincident. It is expected that a strong interaction among the multiple points results in the fixing state of the present invention. In the present invention, such as one represented by 2′ in FIG. 1B, the state in which part of the surface area (e.g., 30% or more thereof) of the chargeable pseudo-fine particle is in touch with the colorant is referred to as “fusion” for convenience. However, it is one of the forms of fixing, so the chargeable pseudo-fine particle and the colorant may not be blended in each other in their interface.

In particular, strong interactions are exerted among constituent polymers inside the chargeable resin pseudo-fine particle, so, in some cases, the constituent polymers are twisted up each other and physical linkages are formed among them. Thus, even in the case where the chargeable resin pseudo-fine particle has many hydrophilic groups, no chargeable resin pseudo-fine particle fixing on the colorant is detached therefrom, or no resin components having hydrophilic groups is continuously eluted out of the chargeable resin pseudo-fine particle. In contrast, such encapsulation method as disclosed in JP 08-183920 A may not provide sufficient long-term storage stability because a resin having high hydrophilicity cannot strongly bind to a colorant, so it is detached from the colorant.

In addition, as a merit of allowing the chargeable resin pseudo-fine particle to fix on the colorant in the dispersible colorant to be used in the present invention, such a configuration increases the specific surface area of the dispersible colorant and, on many portions of the surface of the colorant, charge on the surface of the chargeable resin pseudo-fine particle can be distributed. As a result, the dispersible colorant has a high specific surface area, so the charge of the chargeable resin pseudo-fine particles can be provided as charge on the surface of the dispersible colorant with extremely high efficiency. In other words, the configuration of the dispersible colorant to be used in the present invention is a configuration that more efficiently provides the surface of the dispersible colorant with more surface charge. Therefore, the above configuration of the dispersible colorant of the present invention can provide higher dispersion stability than that of the configuration of a colorant covered with a resin as typified by JP 08-183920 A even when a resin component has a smaller substantial acid value or amine value.

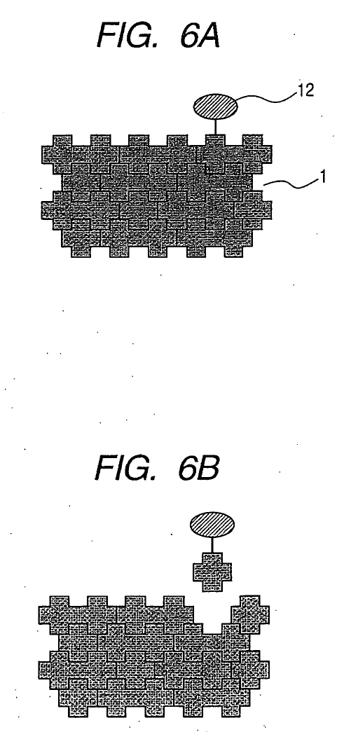

In general, an organic pigment is insolubilized (turned into a pigment) by the crystallization of a colorant molecule having coloring property due to a strong interaction. In the case of a dispersible colorant using an organic pigment as the colorant to be used in the present invention, as described above, multiple interaction points are randomly distributed at the interface between the chargeable resin pseudo-fine particle and the colorant. Thus, the chargeable resin pseudo-fine particles 11 can fix over several colorant molecules 1a in the pigment particles (see FIG. 5). Therefore, the “pigment detachment”, which occurs when the colorant molecule 1a is locally provided with hydrophilicity by a hydrophilic group 12, as explained by FIGS. 6A and 6B, does not occur in the present invention. Preferably, when the organic pigment is used as a colorant, the size of the chargeable resin pseudo-fine particle may be adjusted so as to be smaller than the particle size of the dispersed pigment but larger than the colorant molecule. Consequently, a dispersible colorant using an organic pigment provided with high dispersibility can be obtained without any disturbance of the crystal structure of the pigment.

In the present invention, the state where the colorant “fixes” the chargeable resin pseudo-fine particles can be confirmed by the procedure with three separation stages for facility as described below. At first, the first separation separates the colorant to be confirmed from other water-soluble components (including a water-soluble resin component) in ink or a water dispersing element. Then, the second separation separates the colorant in a sediment generated by the first separation from a water-insoluble resin component. Furthermore, the third separation separates the resin component being absorbed weakly from the dispersible colorant fixing chargeable resin pseudo-fine particles. Subsequently, the quantitative determination of the resin component in the supernatant obtained by the third separation and comparison between the sediment from the second separation and the sediment from the third separation are carried out, respectively. Consequently, the fixation between the colorant and the chargeable resin pseudo-fine particle can be confirmed.

More specifically, for example, the fixation can be confirmed by the following conditions. 20 g of ink or a water dispersing element into which a colorant is dispersed are taken and then adjusted so that the mass of the total solid content can be about 10%, followed by the first separation by means of a centrifugal separator at 12,000 rpm for 60 minutes. Among the separated products, the sediment of the lower layer containing the colorant is re-dispersed in about three volumes of pure water and then the whole is subjected to the second separation at 80,000 rpm for 90 minutes. The sediment of the lower layer containing the colorant re-dispersed in three volumes of pure water is subjected to the third separation at 80,000 rpm for 90 minutes, to thereby take out the sediment of the lower layer containing the colorant. Each of the sediments from the second and third separations is taken so as to be about 0.5 g in solid content, followed by drying at 30° C. for 18 hours under reduced pressures. The resulting product is observed by a scanning electron microscope at a magnification of 50,000. It is determined that resin pseudo-fine particles fix on the colorant when the multiple fine particulate substances or minute aggregates based thereon, which are attached on the surface of the observed dispersible colorant, were confirmed and when the sediments from the second and third separation have the same configuration. Furthermore, the supernatant fraction of the upper layer obtained by the third separation is gently taken so as to become almost half in volume and the percent mass of a solid content is then calculated from variations in mass before or after drying at 60° C. for 8 hours. When the variations are less than 1%, the resin pseudo-fine particles may not be detached from the dispersible colorant. Thus, it can be judged that the resin pseudo-fine particles have fixed on the dispersible colorant.

The conditions of the respective separations described above are preferable examples. Any of other separation methods or separation conditions may be applied as a method of determining the dispersible colorant to be used in the present invention as far as it is a procedure for attaining the intents of the first, second, and third separation procedures. In other words, the first separation intends to separate the colorant in ink and a water dispersing element and the resin component adsorbed thereon from the water soluble component. The second separation intends to separate the colorant and the resin component fixing on the colorant from other resin components adsorbed on the colorant. Furthermore, the third separation intends to confirm that the resin component fixing on the colorant is not detached therefrom. Needless to say, any of other known or newly developed separation procedures may be used as far as it is a separation procedure for attaining the respective intents of the first, second, and third separation procedures. Besides, the number of the separation procedures to be applied may be smaller or larger than three.

A second feature of the dispersible colorant to be used in the present invention lies in that the dispersible colorant can be independently dispersed into an aqueous medium while allowing the chargeable resin pseudo-fine particle 2 to fix on the water-insoluble colorant 1. As described above, the dispersible colorant to be used in the present invention is a self-dispersible colorant, which can be essentially dispersed into water or aqueous ink in a stable manner even without the aid of another substance such as a surfactant or a polymer dispersant. The definition and criterion of such a term will be described later in detail. Therefore, the dispersible colorant to be used in the present invention does not require the addition of a polymer dispersant or any other resin component, which may be detached in the long term, or of a surfactant component, for the purpose of stabilizing the dispersion of the colorant. As a result, when the dispersible colorant to be used in the present invention is used as the aqueous ink, the design freedom with respect to any component except the dispersible colorant becomes large. For instance, aqueous ink can be prepared as one which is capable of attaining a sufficiently high printing density even on a recording medium having high permeability to ink, such as plain paper.

The self-dispersibility of the dispersible colorant to be used in the present invention can be confirmed, for example, by the following method. The ink or water dispersing element into which the colorant is being dispersed is diluted with pure water by 10-fold and then condensed up to the original concentration using an ultrafilter with a molecular weight cut off of 50,000. Subsequently, the concentrate is separated by a centrifugal separator at 12,000 rpm for 2 hours, and a sediment is then collected and re-dispersed into pure water. At this time, the sediment which can be re-dispersed well is defined as one having self-dispersibility. It is collectively determined whether or not the sediment is re-dispersed well by the criteria, for example, as follows: the uniform dispersion is observed by sight; any conspicuous sediment occurs while standing for 1 to 2 hours; even if the sediment has occurred, it can be restored by shaking; when the diameters of the dispersed particles are measured by means of dynamic light scattering, the average particle size of the dispersed particles is within the range of 2 folds of the particle size before the operation.

As described above, the dispersible colorant to be used in the present invention has the form having a high specific surface area as the colorant fixes the chargeable resin pseudo-fine particle. The dispersible colorant has much charge on its wide surface, so it realizes excellent storage stability. Therefore, the chargeable resin pseudo-fine particles provide further preferable results when many (multiple) chargeable resin pseudo-fine particles are dotted and fix on the colorant. In particular, it is desirable that there be a predetermined distance between the fixing chargeable resin pseudo-fine particles, preferably with uniform distribution for the colorant, more preferably in the state that part of the surface of the colorant particle is exposed between the chargeable resin pseudo-fine particles. Such conditions can be confirmed by observing the aqueous ink according to the present invention with a transmission electron microscope or a scanning electron microscope. In other words, the multiple chargeable resin pseudo-fine particles are observed to fix on the surface of the colorant while keeping a predetermined distance between the particles, or the surface of the colorant is observed to be exposed between the chargeable resin pseudo-fine particles fixing thereon. Furthermore, the chargeable resin pseudo-fine particles may be observed such that they are partially in close proximity to one another or fused together. However, in any of those cases, there is a certain distance between the chargeable resin pseudo-fine particles as a whole and there are some exposed portions of the surface of the colorant. Besides, when such states are distributed, it will be evident for a person skilled in the art that the chargeable resin pseudo-fine particles are deemed to be dotted and fix on the colorant.

Furthermore, it has become evident that the aqueous ink containing the dispersible colorant to be used in the present invention having such characteristics as described above shows excellent quick-drying property on a recording medium. This reason is not sure, but it may depend on the following mechanism. As described above, the dispersible colorant is dispersed into ink in the state that the chargeable resin pseudo-fine particles fix on the surface of the colorant. When the ink reaches a recording medium, the aqueous solvent in the ink (hereinafter, referred to as an ink solvent) is absorbed into fine pores on the recording medium (gaps between cellulose fibers in the case of plain paper, while fine pores in a receiving layer of coated or glossy paper) through a capillary phenomenon. Then, on the dispersible colorant to be used in the present invention, owing to the structural features of the material, there are chargeable resin pseudo-fine particles dotted on the portion where the colorants contact with each other, thereby forming many fine gaps. As a result, a capillary phenomenon acts on the ink solvent existing between colorants, so the ink solvent between the colorants can be quickly absorbed in the recording medium. Out of the aqueous inks according to the present invention, one using a dispersible colorant configured such that chargeable resin pseudo-fine particles are dotted on its surface shows more preferable quick-drying property. Therefore, it is expected that the quick-drying property can be achieved by the mechanism described above.

The surface functional group density of the dispersible colorant according to the present invention is preferably.250 μmol/g or more and less than 1,000 μmol/g, or more preferably 290 μmol/g or more and less than 900 μmol/g. A dispersible colorant having a surface functional group density smaller than the above range may be poor in long-term storage stability. In addition, a dispersible colorant having a surface functional group density considerably larger than the above range has excessively high dispersion stability, so it is apt to penetrate into a recording medium, and hence it may be difficult to ensure a high printing density.

The surface functional group density is determined, for example, as follows. First, a large excessive amount of an aqueous solution of hydrochloric acid (HCl) is added to a water dispersing element or ink containing a dispersible colorant to be measured, and the whole is centrifuged at 20,000 rpm for 1 hour by means of a centrifugal separator for precipitation. The precipitate is recovered and re-dispersed into pure water, and a solid fraction is determined by means of a drying process. The re-dispersed precipitate is weighed. A known amount of sodium hydrogen carbonate is added, and the whole is stirred to prepare a dispersion liquid. The dispersion liquid is additionally centrifuged at 80,000 rpm for 2 hours by means of a centrifugal separator for precipitation. The supernatant is weighed, and a neutralization amount is determined from neutralization titration by means of 0.1N hydrochloric acid. The known amount of sodium hydrogen carbonate is subtracted from the neutralization amount to determine the surface functional group density as a number of moles per 1 g of the colorant.

Next, the respective components constituting the dispersible colorant to be used in the present invention will be described.

[Colorant]

A colorant, which is one of the components of the dispersible colorant to be used in the present invention, will be described. Out of the conventionally known colorants and the colorants to be newly developed, a colorant which is insoluble in water and can be stably dispersed into water together with a dispersant is desirably used as the colorant to be used in the present invention. Examples of such colorant include a hydrophobic dye, an inorganic pigment, an organic pigment, a metal colloid, and a colored resin fine particle. A colorant having a particle size of a dispersed particle in the range of preferably 0.01 to 0.5 μm (10 to 500nm), or particularly preferably 0.03 to 0.3 μm (30 to 300 nm) is used. The dispersible colorant using a colorant dispersed to have a particle size in such range becomes a preferable dispersible colorant which provides an image having high coloring power and high weatherability when the dispersible colorant is used as aqueous ink. Such particle size of a dispersed particle is a cumulant average value of particle sizes measured by means of dynamic light scattering.

Examples of the inorganic pigment that may be usefully used for a colorant in the present invention include carbon black, titanium oxide, zinc white, zinc oxide, tripon, iron oxide, cadmium red, molybdenum red, chromium vermilion, molybdate orange, chromium yellow, chromium yellow, cadmium yellow, yellow oxide, titanium yellow, chromium oxide, viridian, cobalt green, titanium cobalt green, cobalt chromium green, ultramarine, ultramarine blue, iron blue, cobalt blue, cerulean blue, manganese violet, cobalt violet, and mica.

Examples of the organic pigment that may be usefully used in the present invention include various pigments such as azo-based, azomethine-based, polyazo-based, phthalocyanine-based, quinactidone-based, anthraquinone-based, indigo-based, thioindigo-based, quinophthalon-based, benzimidazolon-based, isoindoline-based and isoindolinon-based pigments.

Examples of an organic water-insoluble color material that may be used in the present invention include hydrophobic dyes such as azo-based, anthraquinone-based, indigo-based, phthalocyanine-based, carbonyl-based, quinonimine-based, methine-based, quinoline-based, and nitro-based dyes. Of those, a disperse dye is particularly preferable.

[Chargeable Resin Pseudo-Fine Particles]

The chargeable resin pseudo-fine particles, which are other components of the dispersible colorant to be used in the present invention, are defined as a microbody obtained by the agglomeration of resin components each of which: is substantially insoluble in water; has a small dispersion unit (particle size of a dispersed particle) in water (or ink) of a colorant on which the components are to fix; and has a sufficiently high degree of polymerization. The microbody is virtually close to a spherical body, or the sizes of multiple microbodies (the chargeable resin pseudo-fine particles) match with each other in a certain range. The resin components constituting the chargeable resin pseudo-fine particles are desirably physically or chemically cross-linked with each other. Whether the resin components constituting the chargeable resin pseudo-fine particles are cross-linked with each other can be confirmed by means of, for example, the following approach. The resin components constituting the chargeable resin pseudo-fine particles are estimated in advance by means of a conventional analysis method. Linear polymers having the same chemical structure, (or the same monomer unit composition) are synthesized by means of solution polymerization, and the chargeable resin pseudo-fine particles and the polymers are each impregnated with an organic solvent as a good solvent to the polymers to compare the solubilities of the particles and polymers. When the solubility of each of the chargeable resin pseudo-fine particles is lower than that of each of the polymers, the chargeable resin pseudo-fine particles are cross-linked inside them.

As another preferable embodiment, the cumulant average value of the particle sizes of the chargeable resin pseudo-fine particles dispersed into water, if measurable by means of dynamic light scattering, is desirably in the range of 10 nm or more, to 200 nm or less. The polydispersity index of the particle sizes of the dispersed particles is preferably less than 0.2 from the viewpoint of long-term storage stability of the dispersible colorant. When the center value of the particle sizes of the dispersed particles is larger than 200 nm or the polydispersity index is larger than 0.2, an original object, that is, to finely disperse, and stabilize the dispersion of the colorant, cannot be sufficiently achieved in some cases. When the average value of the particle sizes of the dispersed particles is smaller than 10. nm, the forms as the chargeable resin pseudo-fine particles cannot be maintained sufficiently, and the resin is apt to be dissolved into water, so no merit of the present invention is obtained in some cases. On the other hand, the stabilization of dispersion of the colorant by the fixing of the chargeable resin pseudo-fine particles in the present invention is effectively expressed when the average value is in the range of 10 nm or more to 200 nm or less and the diameters of the chargeable resin pseudo-fine particles are smaller than those of the colorant particles themselves. The above preferable embodiment holds true for the case where the particle sizes of the dispersed chargeable resin pseudo-fine particles cannot be measured, and in such case, the average particle size of the chargeable resin pseudo-fine particles determined as a result of observation with an electron microscope may be in the preferable range described above or a range comparable thereto.

In addition, when the colorant is an organic pigment, on condition that the above range is satisfied, the size of each of the chargeable resin pseudo-fine particles is particularly desirably smaller than the particle size of the dispersed pigment and larger than the size of the colorant molecule as described above because a dispersible colorant having an extremely stable structure and high dispersibility can be obtained.

The term “chargeable” as used herein refers to a state where a chargeable one holds a certain form of ionized functional group in an aqueous medium, or desirably is self-dispersible because of its chargeability. Accordingly, whether the particles are chargeable resin pseudo-fine particles can be confirmed by a method involving measuring the surface zeta potential of each of the chargeable resin pseudo-fine particles by any one of conventionally known and arbitrary approaches, a method involving: performing potentiometric titration by means of an approach to be described later; and calculating the chargeability as a functional group density, a method involving adding an electrolyte to the water dispersing element of the chargeable resin pseudo-fine particles to confirm the dependence of the dispersion stability on the electrolyte concentration, or a method involving performing chemical structural analysis of the chargeable resin pseudo-fine particles by means of a conventional approach to examine the presence or absence of an ionic functional group.

Any resin components composed of, for example, natural or synthetic polymers to be generally used and polymers to be newly developed for the present invention can be used as the resin components constituting the chargeable resin pseudo-fine particles without any limitation. Examples of an available resin component include an acrylic resin, a styrene/acrylic resin, a polyester resin, a polyurethane resin, a polyurea resin, a polysaccharide, and a polypeptide. In particular, a polymer or copolymer of a monomer component having a radical polymerizable unsaturated bond to which an acrylic resin or a styrene/acrylic resin belongs can be preferably used because it can be generally used and simplifies the functional design of the chargeable resin pseudo-fine particles.

Specific examples thereof include: monomers each having a carboxyl group such as acrylic acid, methacrylic acid, ecrotonic acid, ethacrylic acid, propyl acrylic acid, isopropyl acrylic acid, itaconic acid, and fumaric acid, and salts of them; monomers each having a sulfonic group such as styrenesulfonic acid, sulfonic acid-2-propylacrylamide, acrylic acid-2-ethyl sulfonate, methacrylic acid-2-ethyl sulfonate, and butyl acrylamide sulfonic acid, and salts of them; and monomers each having a phosphonic acid group such as methacrylic acid-2-ethyl phosphonate and acrylic acid-2-ethyl phosphonate.

The chargeable resin pseudo-fine particles to be preferably used in the present invention are preferably made of a resin having a glass transition temperature of −40° C. to 60° C. A glass transition temperature in this range imparts high film formability to the chargeable resin pseudo-fine particles to cause colorants adjacent to each other on recording paper to form a film, so it is capable of forming a strong colored film. Therefore, high rub-off resistance can be imparted to a printed article obtained by using the dispersible colorant having such constitution.

The glass transition temperature of each of chargeable resin pseudo-fine particles can be measured according to the following procedure. A dispersible colorant is subjected to acid precipitation with hydrochloric acid or the like to recover the precipitate. Furthermore, the precipitate is subjected to Soxhlet extraction by means of an organic solvent such as tetrahydrofuran (THF), and then the organic solvent is distilled off to prepare chargeable resin pseudo-fine particles fixing on a colorant. The resultant chargeable resin pseudo-fine particle components are subjected to differential scanning calorimetry to measure the glass transition temperature. For example, a DSC822e manufactured by METTLER is desirably used. A water dispersion liquid containing a dispersible colorant and a water-soluble nonionic resin at the same time can be separated by means of a centrifugal separator. For example, when the water dispersion liquid is centrifuged at 12,000 rpm, the dispersible colorant can be obtained as a precipitate.

Additional functions can be imparted to the dispersible colorant, and the chargeable resin pseudo-fine particles fixing on a colorant, of the present invention by appropriately selecting kinds and copolymerization ratios of monomers each having a radical polymerizable unsaturated bond of the resin components constituting the chargeable resin pseudo-fine particles on condition that the above-described conditions are satisfied. Specific examples of the monomers include hydrophobic monomers, such anionic hydrophilic monomers as described above, and nonionic hydrophilic monomers.

Examples of the hydrophobic monomers include: (meth) acrylates such as methyl acrylate, ethyl acrylate, isopropyl acrylate, n-propyl acrylate, n-butyl acrylate, t-butyl acrylate, benzyl acrylate, methyl methacrylate, ethyl methacrylate, isopropyl methacrylate, n-propyl methacrylate, n-butyl methacrylate, isobutyl methacrylate, t-butyl methacrylate, tridecyl methacrylate, and benzyl methacrylate; styrene-based monomers such as styrene, α-methyl styrene, o-methyl styrene, m-methyl styrene, p-methyl styrene, and p-tert-butyl styrene; itaconates such as benzyl itaconate; maleates such as dimethyl maleate; fumarates such as dimethyl fumarate; acrylonitrile; methacrylonitrile; and vinyl acetate.

Examples of the hydrophilic monomers each having an anionic group include those described above.

Specific examples of the nonionic hydrophilic monomers include: monomers each having a radical polymerizable unsaturated bond and a hydroxyl group showing strong hydrophilicity in a structure at the same time such as hydroxyethyl (meth)acrylate and hydroxypropyl (meth)acrylate; and monomers each containing an alkylene oxide group such as methoxy polyethylene glycol (meth)acrylate, ethoxy polyethylene glycol (meth)acrylate, polyethylene glycol (meth)acrylate, and polypropylene glycol (meth)acrylate. In addition, various conventionally known or novel oligomers, macromonomers, and the like can be used without any limitation.

The alkylene oxide group-containing monomer is excellent in copolymerizability with the hydrophobic monomer component, and provides good results in terms of the uniformity of the surface properties of the chargeable resin pseudo-fine particles, and uniform fixing and fusing properties with respect to the colorant.

Various properties of the dispersible colorant and the chargeable resin pseudo-fine particles can be appropriately controlled by a large number of control factors such as the kinds and copolymerization ratio of monomers constituting the chargeable resin pseudo-fine particles and the kind and concentration of a polymerization initiator to be used at the time of preparation of the polymer. The chargeable resin pseudo-fine particles are each particularly desirably composed of a copolymer of monomer components containing at least one kind of hydrophobic monomer and at least one kind of hydrophilic monomer out of the monomers listed above. At this time, the chargeable resin pseudo-fine particles are each composed by using at least one kind of hydrophobic monomer, whereby good fixing property with respect to a colorant and good thermal stability can be imparted. Similarly, the chargeable resin pseudo-fine particles are each composed by using at least one kind of hydrophilic monomer, whereby good morphological control and good dispersion stability can be imparted. Therefore, the simultaneous use of those monomers provides chargeable resin pseudo-fine particles which favorably fix on the colorant at all times and have good dispersion stability.

Furthermore, in the present invention, a resin obtained from such monomers as described above by means of a water-soluble radical polymerization initiator in am aqueous precipitation polymerization step preferably has a weigh average molecular weight of 2,000 or more and 20,000 or less. A weight average molecular weight in this range can remove a resin, which has been polymerized but is dissolved into a solution without becoming a chargeable resin pseudo-fine particle, in an ultrafiltration step to be performed subsequently to the aqueous precipitation polymerization step, with improved efficiency.

In the present invention, a chain transfer agent is preferably used as a molecular weight adjustor to control a polymerization reaction in order to set the molecular weight in the above range. Any one of various chain transfer agents can be used in the present invention. Examples of a particularly effective chain transfer agent include thiol-based compounds such as lauryl mercaptan, octyl mercaptan, 2-mercaptoethanol, octyl thioglycolate, and 3-mercaptopropionic acid. The use of such chain transfer agent as described above can set the weight average molecular weight of a resin constituting a dispersible pigment obtained by fixing the chargeable resin pseudo-fine particles to be 20,000 or less. A resin having a weight average molecular weight larger than 20,000 has high viscosity when used for ink, so ejection stability which the present invention aims at achieving is hardly obtained.

In the present invention, the aqueous precipitation polymerization step is preferably divided into two stages composed of: a first stage involving adding one or more kinds of hydrophobic monomers and one or more kinds of hydrophilic monomers for aqueous precipitation polymerization by means of a water-soluble radical polymerization initiator; and a second stage involving further adding one or more kinds of hydrophilic monomers for aqueous precipitation polymerization by means of a water-soluble radical polymerization initiator after the first stage. The reason why such constitution is preferable is as follows. With such constitution, the hydrophilicity of a resin not fixing on a colorant can be enhanced, so the resin not fixing on the colorant can be readily removed through the ultrafiltration step.

An example of a particularly suitable combination of monomers to be used in the present invention includes a combination of: a hydrophobic monomer containing at least benzyl methacrylate or a component selected from alkyl (meth)acrylates; and a hydrophilic monomer containing at least (meth)acrylic acid and a component selected from methoxy polyethylene glycol (meth)acrylates, and long-chain alkyl (meth)acrylates each having a carbon chain having 4 to 40 carbon atoms.

An example of a suitable combination of monomers to be used in the present invention when a polymerization reaction is performed through two stages includes a combination of: a hydrophobic monomer, to be used in a reaction on a first stage containing at least benzyl methacrylate or a component selected from alkyl (meth)acrylates; a hydrophilic monomer to be used in the reaction on the first stage containing at least (meth)acrylic acid and a component selected from methoxy polyethylene glycol (meth)acrylates; and a hydrophilic monomer to be used in a reaction on a second stage containing (meth)acrylic acid. The amounts of the respective monomers to be used are preferably as follows. The hydrophobic monomer to be used in the first reaction on the first stage contains 95 to 30 parts by mass of benzyl methacrylate with respect to 100 parts by mass of the entire monomers. The hydrophilic monomer to be used in the reaction on the first stage is a mixture containing 1 to 30 parts by mass of (meth)acrylic acid and 4to 40 parts by mass of one or more components selected from methoxy polyethylene glycol (meth)acrylates and long-chain alkyl (meth)acrylates each having a carbon chain having 4 to 40 carbon atoms with respect to 100 parts by mass of the entire monomers.

An example of another suitable combination of monomers to be used in the present invention when a polymerization reaction is performed through two stages includes a combination of: a hydrophobic monomer to be used in a reaction on a first stage containing benzyl methacrylate; a hydrophilic monomer to be used in the reaction on the first stage containing alkylamine (meth)acrylate and one or more kinds of components selected from methoxy polyethylene glycol (meth)acrylates and long-chain alkyl (meth)acrylates each having a carbon chain having 4 to 40 carbon atoms; and a hydrophilic monomer to be used in a reaction on a second stage containing alkylamine (meth)acrylate.

[Synthesis of Chargeable Resin Pseudo-Fine Particle and Fixation Thereof to Colorant]

A method of synthesizing the chargeable resin pseudo-fine particle and a method of allowing the particle to fix on the colorant can be carried out by the conventional method for the synthesis of chargeable resin pseudo-fine particles or the conventional method of making a complex between the chargeable resin pseudo-fine particles and the colorant whose procedures and processes are well known in the art. In contrast, the inventors of the present invention have made extensive studies to invent a manufacturing method, which is characteristic of the present invention, with which a dispersible colorant containing a colorant and a chargeable resin pseudo-fine particle smaller than the colorant in which the chargeable resin pseudo-fine particle fixes on the colorant can be easily obtained. Hereinafter, a suitable method of manufacturing a dispersible colorant with which a dispersible colorant to be used in the present invention can be easily obtained will be described.

The investigation conducted by the inventors of the present invention has revealed that the dispersible colorant having such properties as described above can be manufactured very simply by application of an aqueous precipitation polymerization method under the conditions below. The manufacturing method involves the steps of: dispersing a water-insoluble colorant by means of a dispersant to prepare an aqueous: dispersion liquid of the water-insoluble colorant; and subjecting a radical polymerizable monomer to aqueous precipitation polymerization in the aqueous dispersion liquid by means of an aqueous radical polymerization initiator to allow a chargeable resin pseudo-fine particle to fix on a colorant. The dispersible colorant obtained through the aqueous precipitation polymerization step is a water-insoluble colorant composed of a colorant on which chargeable resin pseudo-fine particles which have been synthesized in the aqueous precipitation polymerization step are strongly fixed in the state of being uniformly dotted. Besides, the dispersible colorant is excellent in dispersion stability by itself. In the aqueous precipitation polymerization step, the properties of the chargeable resin pseudo-fine particle can be simply adjusted to preferable ones as described above. In this case, furthermore, the state of fixation of the chargeable resin pseudo-fine particle on the colorant, which is characteristic of the present invention, can be attained well. Hereinafter, preferred embodiments of the above manufacturing method will be described in more detail.

(Dispersion of Water-Insoluble Colorant)

First, such water-insoluble colorant to be preferable used in the present invention as described above is dispersed into a dispersant to prepare a water dispersing element. Any one of ionic and nonionic dispersants and the like can be used for dispersing the colorant into an aqueous solution. Of those, a polymer dispersant or a water-soluble polymer is desirably used from the viewpoint of maintaining dispersion stability in a subsequent polymerization step. One exhibiting sufficient water solubility and having hydrophobic portions serving as adsorption sites to the surface of a colorant fine particle and to an oil droplet interface of a radical polymerizable monomer to be added in a polymerization step, especially a hydrophobic monomer, is particularly preferably used. At least one kind of hydrophobic monomer to be used in a subsequent polymerization step is further desirably present as a unit constituting a dispersant because the fixation of the chargeable resin pseudo-fine particles on the colorant in a subsequent polymerization step can be easily induced.

Methods of manufacturing a polymer dispersant and a water-soluble polymer each of which can function as a dispersant that can be used in the present invention are not particularly limited. For example, a polymer dispersant or a water-soluble polymer can be manufactured by allowing a monomer having an ionic group and another monomer polymerizable with the foregoing monomer to react with each other in a non-reactive solvent in the presence or absence of a catalyst. In particular, it has been revealed that good results can be obtained by using a dispersant selected from styrene/acrylic polymer compounds each obtained by polymerizing such monomer having an ionic group as described above and a styrene monomer as essential ingredients, and ionic group-containing, acrylic polymer compounds each obtained by polymerizing a monomer having an ionic group and a (meth)acrylate monomer having 5 or more carbon atoms as essential ingredients. In the case where a dispersible colorant to be obtained aims at having, in particular, an anionic group, an anionic dispersant is desirably selected. On the other hand, in the case where a dispersible colorant to be obtained aims at having, in particular, a cationic group, a dispersant having a cationic group or a nonionic dispersant is desirably selected.

An anionic dispersant having an acid value of 100. or more and 250 or less, or a cationic dispersant having an amine value of 150 or more and 300 or less is desirably used for achieving compatibility between the promotion of the fixation of the chargeable resin pseudo-fine particles on the colorant in a subsequent aqueous polymerization step and the maintenance of the dispersion stability of the colorant in a polymerization step. When each of the acid value and the amine value is smaller than the range, the affinity between the hydrophobic monomer and the dispersant becomes higher than the affinity between the colorant and the dispersant at the time of aqueous precipitation polymerization, so the dispersants is detached from the surface of the colorant before the chargeable resin pseudo-fine particles fix on the colorant, and the state of dispersion cannot be maintained in some cases. When each of the acid value and the amine value is larger than the range, the excluded volume effect and electrostatic repulsion of the dispersant on the surface of the colorant become so strong that the fixation of the chargeable resin pseudo-fine particles on the colorant is inhibited in some cases. When an anionic dispersant is used, a dispersant having a carboxyl group as an anionic group is preferably selected because it does not inhibit the fixation of the resin fine particles on the colorant.

In the process of turning the water-insoluble colorant into the aqueous dispersion liquid by means of the dispersant, the colorant is dispersed such that the particle size of the dispersed colorant is preferably 0.1 μm or more and 0.5 μm or less (10 nm or more and 500 nm or less), particularly preferably 0.03 μm or more and 0.3 μm or less (30 nm or more and 300 nm or less). The particle size of the dispersed colorant in this process is greatly reflected in the particle size of the dispersed dispersible colorant to be obtained. Therefore, the particle size of the dispersed colorant is preferably within the range from the viewpoints of the coloring power described above, the weatherability of an image, and the dispersion stability.

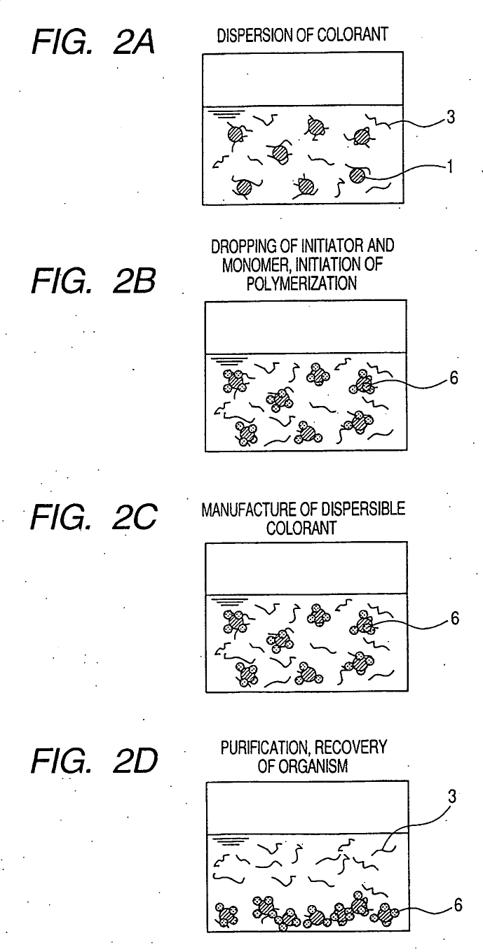

The particle size distribution of the dispersed water-insoluble colorant to be used in the present invention is preferably as monodisperse as possible. In general, the particle size distribution of the dispersible colorant obtained by the fixation of the chargeable resin pseudo-fine particles tends to be narrower than the particle size distribution of the aqueous dispersion liquid prior to the polymerization step shown in FIG. 2B, but basically depends on the particle size distribution of the aqueous dispersion liquid described above. In addition, it is important to narrow the particle size distribution of the colorant in order to surely induce the fixation of the chargeable resin pseudo-fine particles on the colorant by virtue of heterogeneous aggregation. According to the investigation by the inventors of the present invention, the use of a colorant having a polydispersity index of 0.25 or less provides a dispersible colorant with excellent dispersion stability.

Here, the particle size of the colorant in the state of being dispersed varies depending on various measurement systems. In particular, there is an extremely small chance that the organic pigment is spherical. In the present invention, however, the average particle size and the polydispersity index used are obtained by: the measurement, which is performed on the basis of a dynamic light scattering method with an ELS-8000- manufactured by Otsuka Electronics Co., Ltd.; and the cumulant analysis of the results.

The method of dispersing the water-insoluble colorant into water may be any one of methods each involving the use of the dispersant as described above among those by which the colorant can be stably dispersed into water under such conditions as described above, and is not specifically limited to any one of the conventionally known methods. Alternatively, it may be a dispersion method which is newly developed for the present invention. In general, for example, when the water-insoluble colorant is a pigment, a suitable dosage of the polymer dispersant used is suitably 10 mass % or more and 130 mass % or less with respect to the pigment.

The method of dispersing the colorant used in the present invention is not specifically limited as far as it is any of those generally used for the respective colorants including: dispersers such as a paint shaker, a sand mill, an agitator mill, and a three-roll mill; high-pressure homogenizers such as a microfluidizer, a nanomizer, and a multimizer; and an ultrasonic disperser.

(Aqueous Precipitation Polymerization)

Next, a preferred embodiment of aqueous precipitation polymerization, which is the process involving synthesizing a chargeable resin pseudo-fine particle, which is characteristic of the present invention, and then fixing the chargeable resin pseudo-fine particle on a colorant. It should be, noted that the present invention is not limited to any embodiment described below at all. FIGS. 2A to 2D are process views schematically illustrating the process flow of the manufacturing method described above. In this process, the steps to obtain the dispersible colorant can be thought of as follows. At first, as shown in FIG. 2A, a colorant 1 is dispersed into an aqueous solution by means of a dispersant 3 to prepare an aqueous dispersion liquid. In this case, the colorant is adsorbed to the dispersant and thus stabilized in dispersion. Therefore, the adsorption is in a thermally balanced state. Next, the aqueous dispersion liquid, which has been prepared in FIG. 2A, is heated while being stirred, and is added with monomer components 4 together with, for example, an aqueous radical polymerization initiator 5 (see FIG. 2B). The added aqueous radical polymerization initiator is heated up, thereby being cleaved to generate radicals which contribute to a reaction between a hydrophobic monomer dissolved in a small amount into an aqueous phase and a water-soluble monomer in the aqueous phase out of the monomer components added to the aqueous dispersion liquid.

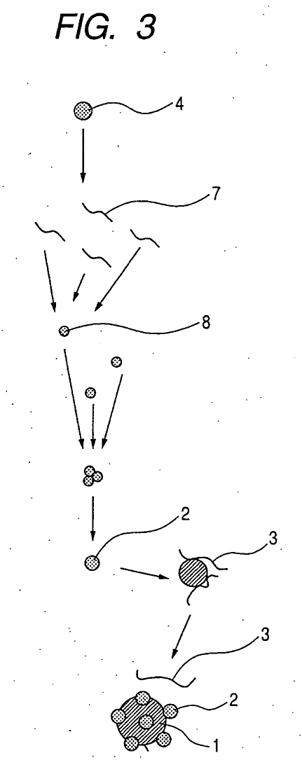

FIG. 3 is a schematic view that illustrates the steps from the polymerization of the monomers 4 to the generation of a dispersible colorant. When the reaction of the monomers 4 described above proceeds, an oligomer 7 generated by a polymerization reaction of the monomer components becomes insoluble in water and is then precipitated from the aqueous phase as a precipitate 8. However, the oligomer 7 precipitated at this time does not have sufficient dispersion stability, so it may be combined with other oligomers to form a chargeable resin pseudo-fine particle 2. The chargeable resin pseudo-fine particles 2 undergo heterogeneous aggregation using the hydrophobic surface of the colorant in the aqueous dispersion liquid as a nucleus, resulting in strong adsorption caused by the hydrophobic interaction between the surface of the colorant 1 and the resin component constituting the chargeable resin pseudo-fine particle 2. At this time, inside the chargeable resin pseudo-fine particle 2, the polymerization reaction continues to proceed. Therefore, the particle changes its form to be more stable with respect to energy while increasing the number of adsorption points with the colorant 1. Simultaneously, the inside of the chargeable resin pseudo-fine particle 2 is highly, physically cross-linked, so the particle can be adsorbed to the colorant 1 in the most stable manner, thereby resulting in a fixing state. On the other hand, the colorant 1 becomes stable as multiple chargeable resin pseudo-fine particles 2 are fixed on the colorant 1 one after the other. Thus, the dispersant 3 which has been in the balanced state, is detached from the surface of the colorant 1 (see. FIGS. 2C and 2D). In the present invention, not only the dispersant 3 which is detached at this time but also a resin which has undergone aqueous precipitation polymerization but is dissolved into a solution without becoming a chargeable resin pseudo-fine particle can be efficiently removed.

FIG. 4 shows a schematic view viewed from the interface on which the chargeable resin pseudo-fine particles 2 thus obtained fix on the colorant 1. As shown in FIG. 4, in the chargeable resin pseudo-fine particle, which is an aggregate of resin components, there are hydrophilic monomer units 9-1, hydrophobic monomer units 9-2, and so one, which are arbitrarily distributed. Therefore, there are distributed local surface energies and an infinite number of adsorption points 10 that correspond to the surface energies of the colorant.

FIG. 5 shows an enlarged schematic view of the fixing interface between part of the chargeable resin pseudo-fine particles 11 and a part 1a of the colorant particle. The interface of the chargeable resin pseudo-fine particle 11 is adsorbed to the adsorption point 10 shown in FIG. 4, while being configured so as to be fit to the surface configuration of the part 1a of the colorant, thereby resulting in stable fixation. As described above, in this process, the polymerization reaction still proceeds inside the chargeable resin pseudo-fine particle. Therefore, the chargeable resin pseudo-fine particle is adsorbed while keeping the adsorption in stable, so the fixation thereof on the colorant can be attained. From the process as described above, the dispersible colorant constructed as described above can be easily formed (see FIG. 2D). At this time, in a system where the chargeable resin pseudo-fine particle has sufficient surface charge and attains its self-dispersibility, electrostatic repulsion acts between the chargeable resin pseudo-fine particles, mutually, during the steps of adsorption and fixation on the colorant with the heterogeneous aggregation. Therefore, the chargeable resin pseudo-fine particles are dotted and fixed on the colorant, thereby becoming a preferred configuration as described above.

The polymerization reaction conditions may vary depending on the natures of the polymerization inhibitor, dispersant, and monomer to be used. For instance, the reaction temperature is set to 100° C. or lower, preferably in the range of 40° C. to 80° C. (both inclusive). In addition, the reaction time period is one hour or more, preferably in the range of 6 hours to 30 hours (both inclusive). The agitating speed during the reaction is in the range of 50 rpm to 500 rpm (both inclusive), preferably in the range of 150rpm to 400 rpm (both inclusive).

In the step described above, particularly, when a chargeable resin pseudo-fine particle is obtained by polymerizing a monomer component containing at least one kind of hydrophobic monomer and at least one kind of hydrophilic monomer, the monomer component is desirably added to the aqueous dispersion liquid of the water-insoluble colorant that contains the aqueous radical polymerization initiator in advance. Alternatively, the monomer component is also desirably added dropwise to the aqueous dispersion liquid of the water-insoluble colorant simultaneously with, or separately from, the aqueous radical polymerization initiator. For uniformly obtaining desired chargeable resin pseudo-fine particles from a mixture of monomers having different properties, such as the hydrophobic and hydrophilic monomers, it is favorable to retain the copolymerization ratio of the monomers having different properties at constant. When an excess amount of the monomer mixture is added to the polymerization system in comparison with the amount of monomers to be consumed for a polymerization reaction in a given time period, there is a tendency that only specific monomer species are polymerized in advance and the remaining monomers polymerize after the consumption of the monomers previously polymerized. In this case, large nonuniformity occurs in the properties of chargeable resin pseudo-fine particles to be produced. Of the chargeable resin pseudo-fine particles thus produced, particularly, those having large contents of hydrophilic monomer components may not fix on the surface of a colorant.

Furthermore, a resin component containing hydrophilic monomer components in large quantities cannot be precipitated in some cases because of its high hydrophilicity, and the resin component may remain as a water-soluble resin component in the system without forming any chargeable resin pseudo-fine particle. On the other hand, the monomer component is added dropwise to the aqueous dispersion liquid of the water-insoluble colorant containing an aqueous radical polymerization initiator, so the copolymerization ratio between the hydrophobic monomer and the hydrophilic monomer can be always kept at constant. Therefore, the chargeable resin pseudo-fine particles constructed with the desired copolymerization ratio can be obtained uniformly.

In particular, when an anionic monomer such as acrylic acid or methacrylic acid is added as a hydrophilic monomer to a polymerization system, the monomer may be partly destabilized depending on the properties of a polymer dispersant for dispersing a colorant to thereby aggregate. For preventing such aggregation, there is also a preferable embodiments in which the anionic monomer may be neutralized in advance and added in the state of a sodium salt or potassium salt.

Through the above steps, a dispersible colorant in which chargeable resin pseudo-fine particles each composed of a desired copolymer fix on the surface of a colorant can be obtained by controlling a large number of control factors. In particular, when an anionic monomer is used for the purpose of obtaining high dispersion stability, the dispersible colorant that has passed the steps of the present invention can have a large surface functional group density even when the amount of the anionic monomer to be used in the above step is relative small, so high dispersion stability can be imparted. As a result, the dispersion stability of the chargeable resin pseudo-fine particles can be increased without any damage to long-term storage stability.

Although the reason for the above is unclear, the inventors of the present invention consider as follows. When a radical generated in water initiates polymerization so that oligomers are precipitated to form chargeable resin pseudo-fine particles, a portion having a large amount of components, derived from an anionic monomer preferentially orients toward an aqueous phase, that is, the vicinity of the surfaces of the chargeable resin pseudo-fine particles. This state is maintained even after the chargeable resin pseudo-fine particles have fixed on a colorant. Furthermore, in the dispersible colorant to be used in the present invention having a structurally large specific surface area, a large number of anionic groups derived from an anionic monomer component are present. As a result, the dispersible colorant obtained by means of the manufacturing method described above is expected to stabilize with the aid of a reduced amount of anionic monomer components.

Furthermore, as described above, in order to realize good ejection stability when the dispersible colorant to be obtained in the present invention is used as a colorant of ink-jet ink, the weight average molecular weight of a resin to be obtained through the above-described aqueous precipitation polymerization step is preferably adjusted to be 2,000 or more and 20,000 or less. A resin having a weight average molecular weight larger than the range is apt to have high viscosity when used for ink. To obtain such dispersible colorant, a chain transfer agent is preferably used as a molecular weight adjustor to control the above-described polymerization reaction. Examples of an available chain transfer agent include compounds each having a thiol group such as lauryl mercaptan, octyl mercaptan, 2-mercaptoethanol, octyl thioglycolate, and 3-mercaptopropionic acid.

As described above, the method according to the present invention is characterized in that a colored resin fine particle is obtained through an ultrafiltration step after aqueous precipitation polymerization. In the ultrafiltration step, the dispersant used for dispersing the colorant at the time of the dispersing step and a resin not forming an emulsion particle can be removed from the aqueous solution of the dispersing element containing the dispersible colorant obtained by fixing chargeable resin pseudo-fine particles. In the present invention, the content of a resin not fixing on the colorant in 10-mass % aqueous solution of the dispersible colorant obtained after the ultrafiltration step is preferably 0.1 mass % or less with respect to the aqueous solution of the dispersible colorant.

In the present invention, it is preferable that the pH of an aqueous solution to be filtered be kept at 9 or more and 13 or less, and a water-soluble organic solvent be added to carry out ultrafiltration. When the solution has a pH lower than the range, a resin not fixing on a colorant in the aqueous solution may precipitate to clog an ultrafilter. When the solution has a pH higher than the range, a resin decomposes, so sufficient dispersibility for dispersing a pigment may not be obtained. Various organic and inorganic bases can be used to set the pH to be 9to 13. Desirably, bases adaptable to ink-jet ink are used. Of those, a strong inorganic base such as lithium hydroxide, sodium hydroxides or potassium hydroxide which has an effect even when it is added a small amount is most preferable.

Examples of a preferable water-soluble organic solvent to be added at the time of the ultrafiltration step include: polyhydric alcohols such as ethylene glycol, diethylene glycol, triethylene glycol, polyethylene glycol, polypropylene glycol, propylene glycol, butylene glycol, 1,2,6-hexane triol, thio glycol, hexylene glycol, glycerin, trimethylolethane, and trimethylolpropane; alkyl ethers of polyhydric alcohols such as ethylene glycol monoethyl ether, ethylene glycol monobutyl ether, diethylene glycol monomethyl ether, diethylene glycol monoethyl ether, diethylene glycol monobutyl ether, triethyleneglycol monomethyl ether, triethylene glycol monoethyl ether, and triethylene glycol monobutyl ether; 2-pyrrolidone; N-methyl-2-pyrrolidone; 1,3-dimethyl-2-imidizolidinone; and triethanolamine. Any one of those may be used without any particular limitation. Desirably, polyhydric alcohols are used in consideration of, for example, the solubility of a resin not adsorbed to a pigment to be removed. Of those, diethylene glycol is most desirable in consideration of general-purpose properties and the like in addition to the solubility. The amount of the water-soluble organic solvent to be added is preferably 5 mass % or more and 40 mass % or less with respect to the aqueous solution containing the dispersible colorant.

In the present invention, conditions such as the kind of membrane to be used for ultrafiltration, a flow rate, and a liquid path can be appropriately selected in accordance with a substance to be removed.

[Aqueous Ink]

The aqueous ink according to the present invention is characterized by containing the dispersible colorant described above, and at least one of a water-soluble nonionic resin and an emulsion particle. When the colorant to be used is a pigment, typically, the content of the pigment is 0.1 mass % or more and 20 mass % or less, or preferably 0.3 mass % or more and 15 mass % or less with respect to ink. Furthermore, water or a mixed solvent containing water and a water-soluble organic solvent as required is a preferable aqueous medium. Besides, a penetrating agent, an antiseptic agent, a mildewproofing agent, or the like may be incorporated to help permeability to the recording medium.

As shown in FIGS. 1A and 1B, the dispersible colorant to be used in the present invention is present in the ink in a state where the chargeable resin pseudo-fine particles 2 fix on the surface of the colorant 1. Therefore, the colorant adheres to a recording medium and an adjacent colorant on the recording medium via the chargeable resin pseudo-fine particles fixing on the surface. Accordingly, a printed article obtained by, using the aqueous ink of the present invention has excellent rub-off resistance.

Furthermore, when a pigment is used as the colorant, a ratio of chargeable resin pseudo-fine particles to a pigment (represented by resin mass/pigment mass=B/P) is desirably set in the range of 0.3 to 4.0 (both inclusive) in the present invention for enhancing the rub-off resistance of a printed article to be formed by means of the colorant. Setting the B/P ratio equal to or larger than 0.3 enhances adhesiveness between colorants and adhesiveness between a colorant and a recording medium, to thereby provide a printed article with excellent rub-off resistance. In particular, film formability of aqueous ink using a dispersible colorant obtained by allowing able resin pseudo-fine particles composed of copolymer components each having a glass transition temperature of −40° C. or higher and 60° C. or lower to fix on a colorant can be expressed with improved effectiveness, whereby rub-off resistance in glossy paper can be enhanced. When the B/P ratio is much larger than 4.0 the ink entirely has high viscosity, and ejection stability may be impaired when the ink is used for an ink-jet recording apparatus. In-addition, the coloring property of the colorant on a recording medium is inhibited and a sufficient printing density is not obtained in some cases because the resin amount is extremely large as compared to the colorant. Setting the value of the B/P ratio in the range of 0.3 to 4.0 (both inclusive) provides aqueous ink that has achieved compatibility between excellent rub-off resistance and ejection stability in an ink-jet recording apparatus.

The term “resin mass” as used herein refers to the total amount of the chargeable resin pseudo-fine particles in the ink according to the present invention, and the total amount also includes the amount of resin components apparently and strongly adsorbed to a pigment surface in some cases; provided, however, that the total amount does not include the amount of water-soluble resin components that can be easily separated from a pigment.

The value of the B/P ratio described above, which can generally be determined by means of differential thermogravimetric analysis, is measured and calculated by means of a TGA/SDTA851 manufactured by METTLER. That is, in the present invention, the dispersible colorant according to the present invention or aqueous ink for ink-jet recording containing the dispersible colorant was centrifuged at 80,000 rpm for 2 hours. The precipitate was dried and weighed and its temperature was increased in a nitrogen atmosphere or in the air. A change in mass before and after the decomposition temperature of each of the pigment and the resin components at the time of temperature increase was determined to calculate the B/P ratio.

[Recorded Image]

The ink according to the present invention can be suitably used for recording using an ink-jet recording apparatus to be described later. A recording medium to be used at this time is not limited, and may be, for example, a medium that enables ink-jet recording.

[Image Recording Method and Recording Apparatus]

The dispersible colorant and the aqueous ink containing the colorant to be used in the present invention can be used in an ink-jet ejection type head and can be useful for an ink tank in which such ink is stored or filling ink for the ink tank. In, particular, out of the different types of ink-jet recording heads, the present invention exerts excellent effects in bubble jet-type recording head and recording apparatus.

As the typical arrangement and principle of the ink-jet recording system, those practiced by use of the basic principle disclosed in, for example, U.S. Pat. Nos. 4,723,129 and 4,740,796 is preferable. The above system is applicable to either one of so-called on-demand type and continuous type. Particularly, in the case of the on-demand type, the system is effective because, by applying at least one driving signal, which corresponds to recording information and gives a rapid temperature rise exceeding nucleate boiling, to each of electrothermal transducers arranged in correspondence with a sheet or liquid channels holding ink, heat energy is generated by the electrothermal transducer to effect film boiling on the heat acting surface of the recording head, and consequently, a bubble can be formed in the ink in one-to-one correspondence with the driving signal. By ejecting the ink through an ejection opening through the growth and shrinkage of the bubble, at least one droplet is formed. The driving signal is more preferably applied as a pulse signal because the growth and shrinkage of the bubble can be attained instantly and adequately to achieve ejection of the ink with the particularly high response characteristics. As the pulse driving signal, signals disclosed in U.S. Pat. Nos. 4,463,359 and 4,345,262 are suitable. Note further that excellent recording can be performed by using the conditions described in U.S. Pat. No. 4,313,124 of the invention, which relates to the temperature rise rate of the heat acting surface.

As an arrangement of the recording head, in addition to the arrangement as a combination of ejection ports, liquid paths, and electrothermal transducers (linear liquid paths or right angle liquid paths) as disclosed in the above specifications, the arrangement using U.S. Pat. Nos. 4,558,333 and 4,459,600, each of which discloses the arrangement having a heat acting portion arranged in a flexed region, is also effective in the present invention. In addition, the present invention is effectively applicable to the structure. (e.g., JP 59-123670 A) in which a common ejection port is used as the ejection portion for multiple electrothermal transducers. Furthermore, a so-called full-line type recording head having a length corresponding to the width of the largest recording medium that can be subjected to recording by the recording apparatus may be configured by combining multiple recording heads as disclosed in the above specifications to fill the length or may be configured as an integrally formed single head. In each case, the present invention can more effectively exert the above effects.

In addition, the present invention is applicable to the use in an exchangeable chip type recording head which can be electrically connected to the apparatus main unit and can receive ink from the apparatus main unit upon being mounted on the apparatus main unit, and a cartridge type recording head which is integrally arranged on the recording head itself. It is preferable to add recovery means, preliminary auxiliary means, or the like, which is provided as an arrangement of the recording apparatus to which the present invention is applicable, to the recording head since the effects of the present invention can be further stabilized. Specific examples of such means include, for the head, capping means, cleaning means, pressurization or suction means, preliminary heating means using electrothermal transducers, another heating element, or a combination thereof, and means for preliminary ejection for ejection separate from recording.

### EXAMPLES

Next, the present invention will be further described specifically with reference to examples and comparative examples. The present invention is not limited by the following examples without departing from the gist of the present invention. Unless otherwise indicated, “part(s)” or “%” in the text is on a mass basis.

### Example 1

A recording ink 1 to be used for Example 1 was prepared as follows.

A mixed solution of 10 parts of carbon black, 6 parts of glycerin, 10 parts of a styrene/acrylic acid-based resin dispersant, and 74 parts of water was dispersed at 1,500 rpm for 5 hours using a sand mill manufactured by KANEDA SCIENTIFIC CO., LTD, thereby obtaining a pigment dispersion liquid 1. In the sand mill, zirconia beads of 0.6 mm in diameter were used and the filling rate in a pot was 70%. Black Pearls 880 available from Cabot Corporation in the U.S. was used as carbon black. The styrene/acrylic resin used as the dispersant was one having a copolymerization ratio of 70:30, Mw=8,000, and an acid value of 170. The styrene/acrylic resin was previously added with water and potassium hydroxide having the above acid value and then the whole was stirred at 80° C. to be turned into an aqueous solution to be used.

100 parts of the pigment dispersion liquid 1 thus obtained were heated to 70° C. in a nitrogen atmosphere. Then, three solutions each containing a monomer, a chain transfer agent, or a water-soluble radical polymerization initiator were gradually added dropwise to the liquid while the liquid was stirred with a motor, to thereby carry out polymerization. The solutions consisted of (1) a solution containing 5.7 parts of methyl methacrylate and 1.0 part of octyl mercaptan, (2) a solution containing 0.3 part, of acrylic acid, 0.25 part of potassium hydroxide, and 20 parts of water, (3) a solution containing 0.04 part of potassium persulfate and 20 parts of waters. After the polymerization for 5 hours, the resultant dispersion liquid was diluted with water by 3-fold, and the solution was centrifuged at 5,000 rpm for 10 minutes to remove an aggregated component.

After that, diethylene glycol and pure water were added to dilute the resultant by 10-fold in such a manner that the concentration of diethylene glycol would be 40%. Then, the pH of the resultant was adjusted to 13 by means of potassium hydroxide. The resultant solution was purified 8 times in total by means of a Filtron, centramate ultrafiltration system manufactured by Pall. The resultant was additionally diluted with pure water by 10-fold, and then the diluted solution was purified twice in total by means of the above ultrafiltration system. After that, the resultant was concentrated to manufacture a dispersible colorant 1. Each purification was performed under the following conditions. That is, a pump output and the pressure in a liquid path were adjusted in such a manner that a total flow rate would be 1 liter/min and a membrane pressure would be 0.05 MPa.

The resultant dispersible colorant 1 was dispersed into water, and the resultant was centrifuged at 12,000 rpm for 60 minutes to re-disperse the precipitate into water. The resultant was dried, and was observed by means of a scanning electron microscope JSM-6700 (manufactured by JEOL) at a magnification of 50,000. As a result, a state was observed, in which a chargeable resin pseudo-fine particle smaller than carbon black as the colorant fixed to the surface of carbon black. The shape of a subsequent dispersible colorant described in examples was observed in the same manner as that described above.

The content of a resin not fixing on a colorant in an aqueous solution of a dispersible colorant was measured&by means of the following method. An aqueous solution was prepared in such a manner that the concentration of the solid content of the resultant dispersible colorant 1 would be 10%. Then, the solution was centrifuged at 25,500 rpm for 3 hours to collect a supernatant aqueous solution. After the supernatant aqueous solution had been dried at 120° C. for 2 hours, the remaining solid content amount was measured. The content of the resin not fixing on the colorant in the aqueous solution of the dispersible colorant was determined to be 0.05% from the remaining solid content amount and the total solid content amount.

Furthermore the weight average molecular weight of the resin was measured by means of a Separations Module manufactured by Waters. The weight average molecular weight Mw was 5,000 in terms of polystyrene.

Next, the following components were mixed in such a manner that the concentration of the above dispersible colorant 1 would be 4%. The mixture was filtered through a membrane filter having a pore size of 2.5 micron under pressure to prepare an ink 1 of this example. The total amount of the ink was adjusted with water to be 100 parts.

| | | |
|---|---|---|
| Glycerin | 7 | parts |
| Diethylene glycol | 5 | parts |
| Trimethylolpropane | 7 | parts |
| Acetylenol EH | 0.1 | part |

| | |
|---|---|
| Ion-exchanged water | Balance |

[Evaluation]

Recording was performed on CANON PPC paper by means of the ink 1 thus obtained to evaluate the ink as follows. A BJS 700 was used as an ink-jet recording apparatus to perform recording. A specific Bk text was continuously printed on 100 sheets, and the wetting of a face surface of a head, kogation on a heater board, and ejection stability after the printing were evaluated by means of the following method according to the following criteria. Table. 1 shows the results.

(Wetting of Face-Surface)

The wetting of a face surface was observed with an optical microscope. The case where no ink droplet was observed around an ejection port was evaluated as ∘. The case where an ink droplet was observed around the ejection port was evaluated as Δ. The case where a belt-shaped ink droplet was observed around the ejection port was evaluated as ×.

(Kogation on Heater Board)

Kogation on a heater board was observed with an optical microscope after ink in ahead had been completely replaced with pure water. The case where no kogation was observed on the heater board was evaluated as ∘. The case where kogation was observed on part of the heater board was evaluated as Δ. The case where kogation was observed on the entire heater board was evaluated as ×.

(Ejection Stability)

A specific Bk text was continuously printed on 100 sheets, and the initial printed article and the last printed article were compared to evaluate ejection stability according to the following criteria.

A: The last printed article has neither stripe nor unevenness, and the initial and last printed articles are identical.

B: The last printed article has a slight stripe, slight unevenness, or slight slippage, but printing can be performed on up to 100 sheets without a significant problem.

C: The last printed article has quality significantly reduced as compared to that of the initial printed article, or printing cannot be performed on up to 100 sheets.

### Example 2

100 parts of the pigment dispersion liquid 1 used in Example 1 were heated to 70° C. in a nitrogen atmosphere. Then, solutions each containing a monomer, a chain transfer agent, or a water-soluble radical polymerization initiator were gradually added dropwise to the liquid while the liquid was stirred with a motor, to thereby carry out polymerization. The solutions used consisted of (1) a solution containing 4.28 parts of benzyl methacrylate, 1.42. parts of methoxy polyethylene glycol methacrylate, and 0.1 part of octyl mercaptan, (2) a solution containing 0.3 part of methacrylic acid, 0.2 part of potassium hydroxide, and 20 parts of water, (3) a solution containing 0.04 part of potassium persulfate and 20 parts of water. After the polymerization for 5 hours, the resultant aqueous solution of a dispersible colorant was diluted with water by 3-fold, and the solution was centrifuged at 5000 rpm for 10 minutes to remove an aggregated component.

After that, diethylene glycol and pure water were added to dilute the resultant by 10-fold in such a manner that the concentration of diethylene glycol would be 5%. Then, the pH of the resultant was adjusted to 9 by means of potassium hydroxide. The resultant solution was purified 8 times in total by means of a Filtron, centramate ultrafiltration system manufactured by Pall. The resultant was additionally diluted with pure water by 10-fold, and then the diluted solution was purified twice in total by means of the above ultrafiltration system. After that, the resultant was concentrated to manufacture a dispersible colorant 2 having a chargeable resin pseudo-fine particle smaller than a colorant and fixing on the surface of the colorant. Each purification was performed under the following conditions. That is, a pump output and the pressure in a liquid path were adjusted in such a manner that a total flow rate would be 1 liter/min and a membrane pressure would be 0.05 MPa.

The content of a resin not fixing on a colorant in a 10% aqueous solution of the dispersible colorant 2 and the weight average molecular weight Mw of the resin were each measured in the same manner as in Example 1. The content and the weight average molecular weight were 0.08% and 16,000, respectively.

Furthermore, an ink 2 was prepared in the same manner as in Example 1 except that the dispersible colorant 2 was used instead of the dispersible colorant 1. Furthermore, the resultant ink 2 was used to form an image in the same manner as in Example 1, and the image was evaluated in the same manner as in Example 1. Table 1 shows the results.

### Example 3

100 parts of the pigment dispersion liquid 1 used in Example 1 were heated to 70° C. in a nitrogen atmosphere. Then, the synthesis of a resin was carried out through two stages consisting of a first stage and a second stage while the liquid was stirred with a motor. A reaction on the first stage involved the use of three kinds of solutions consisting of (1) a solution containing 4.28 parts of benzyl methacrylate, 1.42 parts of methoxy polyethylene glycol methacrylate, and 0.1 part of octyl mercaptan, (2) a solution containing 0.3 part of methacrylic acid, 0.2 part of potassium hydroxide, and 20 parts of water, (3) a solution containing 0.04 part of potassium persulfate and 20 parts of water. The mixture containing the dispersion liquid and the three kinds of solutions was stirred at 70° C. for 5 hours to complete polymerization on the first stage. Then, a reaction on the second stage was carried out. The reaction on the second stage involved the use of a solution containing 0.6 part of methacrylic acid, 0.2 part of potassium hydroxide, and 20 parts of water. The mixture containing a product as a result of the first stage and the solution was stirred at 70° C. for 5 hours to carry out a polymerization reaction. The resultant aqueous solution of a dispersible colorant was diluted with water. By 10- fold, and the solution was centrifuged at 5,000 rpm for 10 minutes to remove an aggregated component.

After that, diethylene glycol and pure water were added to dilute the resultant by 10-fold in such a manner that the concentration of diethylene glycol would be 20%. Then, the pH of the resultant was adjusted to 13 by means of potassium hydroxide. The resultant solution was purified 8 times in total by means of a Filtron, centramate ultrafiltration system manufactured by Pall. The resultant was additionally diluted with pure water by 10-fold, and then the diluted solution was purified twice in total by means of the above ultrafiltration system. After that, the resultant was concentrated to manufacture a dispersible colorant 3 having a chargeable resin pseudo-fine particle smaller than a colorant and fixing on the surface of the colorant. Each purification was performed under the following conditions. That is, a pump output and the pressure in a liquid path were adjusted in such a manner that a total flow rate would be 1 liter/min and a membrane pressure would be 0.05 MPa.

The content of a resin not fixing on a colorant in a 10% aqueous solution of the dispersible colorant 3 and the weight average molecular weight Mw of the resin were each measured in the same manner as in Example 1. The content and the weight average molecular weight were 0.04% and 16,000, respectively.

Furthermore, an ink 3 was prepared in the same manner as in Example 1 except that the dispersible colorant 3 was used instead of the dispersible colorant 1. Furthermore, the resultant ink 3 was used to form an image in the same manner as in Example 1, and the image was evaluated in the same manner as in Example 1. Table 1 shows the results.

### Example 4

A dispersible colorant was manufactured in the same manner as in Example 1 except that three kinds of solutions to be used for aqueous precipitation polymerization were changed to (1) a solution containing 4.28 parts of benzyl methacrylate, 1.42 parts of methoxypolyethylene glycol methacrylate, and 0.1 part of octyl mercaptan, (2) a solution containing 0.3 part of methacrylic acid 0.2 part of potassium hydroxide, and 20 parts of water, (3) a solution containing 0.04 part of potassium persulfate and 20 parts of water.

After that, diethylene glycol was not used, pure water was added to dilute the resultant by 10-fold. Then, the pH of the resultant was adjusted to 12 by means of potassium hydroxide. The resultant solution was purified 8 times in total by means of a Filtron, centramate ultrafiltration system manufactured by Pall. The resultant was additionally diluted with pure water by 10-fold, and then the diluted solution was purified twice in total by means of the above ultrafiltration system. After that, the resultant was concentrated to manufacture a dispersible colorant 4 having a chargeable resin pseudo-fine particle smaller than a colorant and fixing on the surface of the colorant. Each purification was performed under the following conditions. That is, a pump output and the pressure in a liquid path were adjusted in such a manner that a total flow rate would be 1 liter/min and a membrane pressure would be 0.05 MPa.

The content of a resin not fixing on a colorant in a 10% aqueous solution of the dispersible colorant 4 and the weight average molecular weight Mw of the resin were each measured in the same manner as in Example 1. The content and the weight average molecular weight were 0.15% and 15,000, respectively.

Furthermore, an ink 4 was prepared in the same manner as in Example 1 except that the dispersible colorant 4 was used instead of the dispersible colorant 1. Furthermore, the resultant ink 4 was used to form an image in the same manner as in Example 1, and the image was evaluated in the same manner as in Example 1. Table 1 shows the results.

### Example 5

A dispersible colorant was manufactured in the same manner as in Example 2 except that octyl mercaptan to serve as a chain transfer agent was not used.

After that, diethylene glycol and pure water were added to dilute the resultant by 10-fold in such a manner that the concentration of diethylene glycol would be 20%. Then, the pH of the resultant was adjusted to 13 by means of potassium hydroxide. The resultant solution was purified 8 times in total by means of a Filtron, centramate ultrafiltration system manufactured by Pall. The resultant was additionally diluted with pure water by 10-fold, and then the diluted solution was purified twice in total by means of the above ultrafiltration system. After that, the resultant was concentrated to manufacture a dispersible colorant 5 having a chargeable resin pseudo-fine particle smaller than a colorant and fixing on the surface of the colorant. Each purification was performed under the following conditions. That is, a pump output and the pressure in a liquid path were adjusted in such a manner that a total flow rate would be 1 liter/min and a membrane pressure would be 0.05 MPa.

The content of a resin not fixing on a colorant in a 10% aqueous solution of the dispersible colorant 5 and the weight average molecular weight Mw of the resin were each measured in the same manner as in Example 1. The content and the weight average molecular weight were 0.20% and 100,000, respectively.

Furthermore, an ink 5 was prepared in the same manner as in Example 1 except that the dispersible colorant 5 was used instead of the dispersible colorant 1. Furthermore, the resultant ink 5 was used to form an image in the same manner as in Example 1, and the image was evaluated in the same manner as in Example 1. Table 1 shows the results.

### Comparative Example 1

A dispersible colorant 6 was manufactured in the same manner as in Example 1 except that: the amount of octyl mercaptan used was changed to 0.1 part; and no ultrafiltration was performed.

The content of a resin not fixing on a colorant in a 10% aqueous solution of the dispersible colorant 6 and the weight average molecular weight Mw of the resin were each measured in the same manner as in Example 1. The content and the weight average molecular weight were 4.0% and 15,000, respectively.

Furthermore, an ink 6 was prepared in the same manner as in Example 1 except that the dispersible colorant 6 was used instead of the dispersible colorant 1. Furthermore, the resultant, ink 6 was used to form an image in the same manner as in Example 1, and the image was evaluated in the same manner as in Example 1. Table 1 shows the results.

TABLE 1
Evaluation results

| | | | | | | Comparative |
|---|---|---|---|---|---|---|
| | Example | | | | | Example |
| | Ink 1 | Ink 2 | Ink 3 | Ink 4 | Ink 5 | Ink 6 |
| Wetting of | ∘ | ∘ | ∘ | Δ | Δ | x |
| face surface | | | | | | |
| Kogation on | ∘ | ∘ | ∘ | Δ | Δ | x |
| heater board | | | | | | |
| Ejection | A | A | A | B | B | C |
| stability | | | | | | |

This application claims priority from Japanese Patent Application No. 2004-190472 filed on Jun. 28, 2004, which is hereby incorporated by reference herein.

What is claimed is:

1. A method of manufacturing a dispersible colorant using aqueous precipitation polymerization, comprising at least:
a dispersing step of dispersing a colorant into an aqueous solution by means of a dispersant;
an aqueous precipitation polymerization step of adding a resin monomer and a radical polymerization initiator to the solution into which the colorant is dispersed to manufacture a dispersible colorant having a chargeable resin pseudo-fine particle fixing on the colorant by means of aqueous precipitation polymerization; and
an ultrafiltration step of subjecting the aqueous solution containing the dispersible colorant to ultrafiltration to obtain the dispersible colorant.

2. A method of manufacturing a dispersible colorant according to claim 1, wherein the resin obtained by the aqueous precipitation polymerization has a weight average molecular weight of 2,000 or more and 20,000 or less.

3. A method of manufacturing a dispersible colorant according to claim 1, wherein the aqueous precipitation polymerization step is performed through two stages composed of: a first stage involving adding one or more kinds of hydrophobic monomers and one or more kinds of hydrophilic monomers for aqueous precipitation polymerization by means of a water-soluble radical polymerization initiator; and a second stage involving further adding one or more kinds of hydrophilic monomers for aqueous precipitation polymerization by means of a water-soluble radical polymerization initiator after the first stage.

4. A method of manufacturing a dispersible colorant according to claim 1, wherein the content of a resin not fixing on the colorant in a 10-mass % aqueous solution of the dispersible colorant obtained after the ultrafiltration step is 0.1 mass % or less.

5. A method of manufacturing a dispersible colorant according to claim 1, wherein the ultrafiltration step comprises: adjusting the pH of the aqueous solution containing the dispersible colorant obtained by the aqueous precipitation polymerization step to be 9 or more and 13 or less; and adding a water-soluble organic solvent for ultrafiltration.

6. A method of manufacturing a dispersible colorant according to claim 5, wherein the amount of the water-soluble organic solvent to be added is 5 mass % or more and 40 mass % or less with respect to the aqueous solution containing the dispersible colorant.

7. A method of manufacturing a dispersible colorant according to claim 5, wherein the water soluble organic solvent comprises a polyhydric alcohol.

8. A method of manufacturing a dispersible colorant according to claim 7, wherein the polyhydric alcohol comprises diethylene glycol.

9. A method of manufacturing a dispersible colorant according to claim 1, wherein a chain transfer agent is used as a molecular weight adjustor in the aqueous precipitation polymerization step.

10. A method of manufacturing a dispersible colorant according to claim 9, wherein the chain transfer agent comprises a compound having a thiol group.

11. A method of manufacturing a dispersible colorant according to claim 10, wherein the compound having a thiol group comprises one selected from the group consisting of lauryl mercaptan, octyl mercaptan, 2-mercaptoethanol, octyl thioglycolate, and 3-mercaptopropionic acid.

12. An ink-jet recording ink comprising a dispersible colorant obtained by means of the method of manufacturing a dispersible colorant according to claim 1.
